(19) United States
(12) Patent Application Publication
(10) Pub. No.: US 2016/0052354 A1
(43) Pub. Date: Feb. 25, 2016

(54) HIGH-LOAD TOWING EYE

(71) Applicants: Josef SCHARMÜLLER, (US); Josef SCHARMÜLLER, JR., Fornach (AT)

(72) Inventors: JOSEF SCHARMÜLLER, Fornach (AT); JOSEF SCHARMÜLLER, JR., Fornach (AT)

(21) Appl. No.: 14/783,307

(22) PCT Filed: Feb. 18, 2014
(86) PCT No.: PCT/AT2014/000033

§ 371 Date: Oct. 8, 2015

(30) Foreign Application Priority Data
Apr. 9, 2013 (AT) A 268/2013

(51) Int. Cl. B60D 1/06

(52) U.S. Cl. CPC B60D 1/065

(57) ABSTRACT

A high-load towing eye for a vehicle trailer includes a hemispherical receiving socket for receiving a coupling ball, a fastening flange for fastening to the vehicle trailer, and a straight shaft that connects the receiving socket to the fastening flange, wherein the receiving socket has a collar on the open side and the inside diameter of the collar corresponds to the inside diameter of the receiving socket. The height of the inside of the collar is greater on the first side of the receiving socket facing the shaft than on the second side of the receiving socket facing away from the shaft.

The invention relates to a high-load towing eye for a vehicle trailer according to the preamble of patent claim 1.

Such high-load towing eyes are used in particular in agricultural vehicles. In this case, high forces are to be transmitted by the high-load towing eyes, for example, the support load can be multiple tons and the mass of the vehicle trailer can be more than 20 tons. For use in the country, it is also desirable for the coupling system to enable large angles of inclination.

The object of the invention is therefore to specify a high-load towing eye of the type mentioned at the outset, using which large angles of inclination are enabled and a high level of reliability is provided.

This is achieved according to the invention by the features of patent claim 1.

It can be ensured using the collar that even if the high-load towing eye lifts off slightly from the coupling ball, a great circle of the coupling ball is still in contact with the high-load towing eye. It has been shown that the reliability of the high-load towing eye can be maintained by reducing the height of the collar on the second side, but an increase of the achievable angle of inclination can be achieved.

The dependent claims relate to further advantageous embodiments of the invention.

Reference is hereby expressly made to the wording of the patent claims, whereby the claims are incorporated at this point in the description by reference and are considered to be reproduced word for word,

The invention will be described in greater detail with reference to the appended drawings, in which a preferred embodiment is illustrated solely as an example. In the figures:

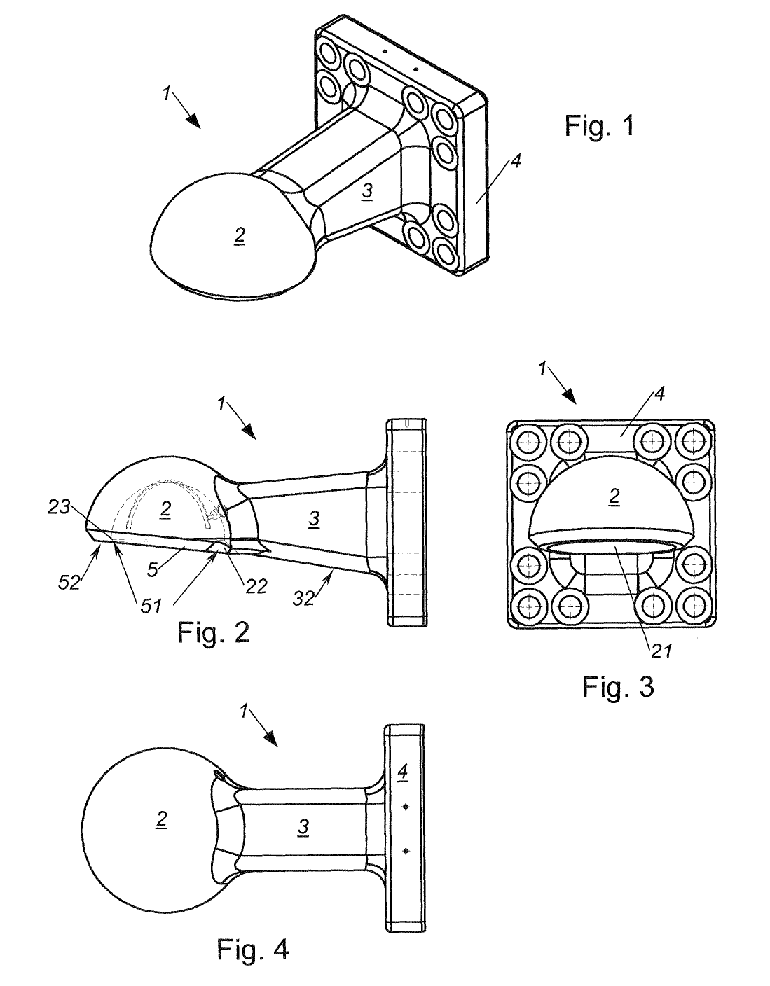

FIG. 1 shows a high-load towing eye in a diagonal view;

FIG. 2 shows the high-load towing eye according to FIG. 1 in a side view;

FIG. 3 shows the high-load towing eye according to FIG. 1 in a front view;

FIG. 4 shows the high-load towing eye according to FIG. 1 in a top view.

FIGS. 1 to 4 show a high-load towing eye 1 for a vehicle trailer having a hemispherical receiving socket 2 for receiving a coupling ball, a fastening flange 4 for fastening to the vehicle trailer, and a linear shaft 3, which connects the receiving socket 2 to the fastening flange 4, wherein the receiving socket 2 has a collar 5 on the open side 21, wherein the internal diameter of the collar 5 corresponds to the internal diameter of the receiving socket 2.

The height of the inner side 51 of the collar 5 on the first side 22 of the receiving socket 2, which faces toward the shaft 3, is greater than on the second side 23 of the receiving socket 2, which faces away from the shaft 3.

Such high-load towing eyes 1 are used in particular in agriculture and typically have support loads greater than 1 ton. However, support loads of three or more tons can also be provided.

The receiving socket 2 is placed on a coupling ball and held on the outer side by a holddown element on the coupling ball. Essentially a great circle of the coupling ball is contacted by the receiving socket on the open side 21 of the receiving socket. This great circle is referred to hereafter as a contact great circle.

The collar 5 forms a protrusion beyond the coupling ball and is not in contact therewith. The height of the collar can normally be measured on the plane formed by the contact great circle.

If the high-load towing eye 1 lifts off of the coupling ball in operation, a part of the collar 5 thus comes into operational contact with the coupling ball.

It has been shown that a low height of the collar 5 is sufficient on the second side 23. In this case, the height of the collar 5 on the inner side 51 can be selected in the range from 1 mm to 3 mm.

Due to the low height of the collar 5 on the second side 23, a particularly large angle of inclination can be achieved. The angle of inclination specifies the maximum pivot of the high-load towing eye 1 about an axis parallel to the rear axle of the towing vehicle in a straight-ahead travel position.

If the holddown element is arranged closer to the second side 23 than to the first side 22, the holddown element on the second side 23 thus reduces the risk of lifting off of the high-load towing eye 1.

The reliability of the high-load towing eye 1 can be ensured on the first side 22 by a greater height of the collar 5.

The high-load towing eye 1 can be screwed onto the vehicle trailer using the fastening flange 4. In this case, the fastening flange 4 can be essentially perpendicular to the axis of the shaft 3, as in the embodiment shown in FIGS. 1 to 4.

It can also be provided that the fastening flange 4 is essentially parallel to the axis of the shaft 3, i.e., pivoted by 90° in relation to the embodiment shown in FIGS. 1 to 4.

The height of the inner side 51 of the collar 5 on the first side 22 can be at least twice, preferably at least three times, in particular at least four times the height of the inner side 51 of the collar 5 on the second side 23.

It has been shown to be particularly advantageous if the height of the inner side 51 of the collar 5 decreases essentially linearly and continuously from the first side 22 toward the second side 23.

The collar 5 can have an essentially level lower side 52. A particularly simple geometry of the high-load towing eye 1 results in this case.

The lower side 52 can enclose an angle in the range of 5° to 10°, preferably in the range of 6° to 8°, with the axis of the shaft 3.

The lower side 52 can enclose an angle in the range of 80° to 95°, preferably in the range of 92° to 94°, with the surface normal to the plane formed by the contact great circle.

The lower side 52 can enclose an angle in the range of 5° to 10°, preferably in the range of 6° to 8°, with the surface normal on the fastening flange 4.

Furthermore, it can be provided that the lower side 52 of the collar 5 merges directly into the lower side 32 of the shaft 3. A particularly compact high-load towing eye 1 can be provided in this case. The angle of inclination is also limited by the shaft 3 in this case.

1-5. (canceled)

6. A high-load towing eye for a vehicle trailer, comprising:
a semispherical receiving socket for receiving a coupling ball,
a fastening flange for fastening to the vehicle trailer; and
a straight shaft connecting the receiving socket with the fastening flange, wherein the receiving socket has an open side provided with a collar, said collar having an inner diameter corresponding to an inner diameter of the receiving socket, wherein a height of an inside of the collar on a first side of the receiving socket facing the shaft is greater than on a second side of the receiving socket facing away from the receiving socket.

7. The high-load towing eye of claim 6, wherein the height of the inside of the collar on the first side is at least twice the height of the inside of the collar on the second side.

8. The high-load towing eye of claim 7, wherein the height of the inside of the collar on the first side is at least three times the height of the inside of the collar on the second side.

9. The high-load towing eye of claim 7, wherein the height of the inside of the collar on the first side is at least four times the height of the inside of the collar on the second side.

10. The high-load towing eye of claim 6 or 2, wherein the height of the inside of the collar decreases substantially linearly and continuously from the first side to the second side.

11. The high-load towing eye of claim 6, wherein the collar has a substantially even bottom side .

12. The high-load towing eye according to claim 4, wherein the bottom side of the collar directly transitions into a bottom side of the straight shaft.
